(19) United States
(12) Patent Application Publication
(10) Pub. No.: US 2001/0003352 A1
(43) Pub. Date: Jun. 14, 2001

(54) CONCEALED VEHICULAR WASHER NOZZLE SYSTEM

(76) Inventors: THOMAS RUDEN, FARMINGTON HILLS, MI (US); STEPHEN BURT, READING (GB)

Correspondence Address: NORMAN P SOLOWAY, HAYES SOLOWAY HENNESSEY GROSSMAN & HAGE, 175 CANAL STREET, MANCHESTER, NH, 03101

(21) Appl. No.: 09/277,459

(22) Filed: Mar. 26, 1999

(51) Int. Cl. B05B 1/10

(52) U.S. Cl. 239/284.2; 239/284.1; 239/566

(57) ABSTRACT

A vehicular surface washer spray system having at least one washer fluid reservoir and a sprayer, including a device for pumping the washer fluid from the reservoir to said sprayer. The sprayer is longitudinally disposed substantially along the periphery of the surface of a vehicle to be sprayed, and substantially hidden from external view, and includes a plurality of spaced openings longitudinally disposed and selectively positioned in the sprayer and angled toward the vehicle surface such that the washer fluid is selectively discharged through the openings in the sprayer and onto a selected region of the vehicle surface. In addition, the system herein provides that the spray apparatus is integrated in the washer fluid reservoir and designed so that no part thereof protrudes above the vehicle hood.

### FIELD OF THE INVENTION

The present invention relates to a concealed vehicular washer nozzle system optionally integrated into a peripheral window/windshield trim or molding, capable of cleaning the surfaces of a windshield, window, mirror, rear window and other similar type surface in an automobile.

### BACKGROUND OF THE INVENTION

All vehicles have windshields or wind screens which periodically require washing or cleaning while under way. There are numerous devices which have been utilized in the past to spray or otherwise discharge washer fluid onto the surface of the windshield working in conjunction with the windshield wipers to wash the surface of the windshield clean. These systems normally provide for a washer fluid reservoir to retain and supply washer fluid under pressure, usually via a pump mechanism, through delivery hoses to a nozzle protruding through the hood or cowl of the automobile, which sprays the washer fluid onto the surface of the windshield. These systems often employ one or more tubes or hoses and couplings leading from the pump to the fluid reservoir and out again to the spray nozzles.

Various other systems utilize a similar arrangement of pump, washer fluid reservoir and plastic tubing, but provide for the nozzle delivery to be arranged in combination with the windshield wiper. In either case, the prior art systems have involved unsightly nozzles and a multitude of separate components, often remote from each other, linked via plastic delivery tubes to a nozzle device which protrudes unsightly from the hood or cowl area of the automobile or is attached to the windshield wiper arm.

For example, in U.S. Pat. No. 3,790,083 entitled “Windshield Washer System”, there is disclosed an improved nozzle means for spraying washer fluid on the surface of an automobile windshield, the nozzle means being arranged for use in combination with an automobile windshield wiper and washer system, the wiper being the standard reciprocating wiper. In U.S. Pat. No. 4,324,363, entitled “Headlamp Washer Assembly Haing A Multiported Flow Valve”, there is described a headlamp washing assembly including spray nozzles disposed above automotive headlamps. In U.S. Pat. No. 4,905,904, entitled “Washing Liquid Jet Device For Automotive Windshield”, there is described a washing liquid jet device for automobile window glass, which comprises a first pumping unit for pumping a liquid in a first vessel, a second pumping unit for pumping liquid in a second vessel, and a joining chamber having a first flow path and second flow path. In U.S. Pat. No. 4,922,570, entitled “Vehicular Windshield Washer System”, there is described a vehicular windshield washer system in combination with a windshield wiper having a wiper arm. In U.S. Pat. No. 5,271,120 entitled “Windshield Wiper and Washing Liquid Reservoir Assembly”, there is disclosed a windshield wiper assembly comprising a drive mechanism for at least one windshield wiper arm, together with a reservoir for a windshield washing liquid. In U.S. Pat. No. 5,799,359 entitled “Windshield Washer and Wiper Assembly”, there is described a windshield wiper assembly for cleaning the windshield of an automobile, comprising an elongated housing, a source of windshield washer fluid under pressure, a perforated bladder within the housing, means for washing the windshield mounted through the housing in contact with the bladder, a wiper blade mounted on the housing and means for deflating the bladder.

One particular system for cleaning headlights is also shown in U.S. Pat. No. 4,285,470, entitled “Self-Contained Headlamp Washer System”. That system includes a headlight washer system in which the washer nozzle assembly is contained within the headlight bezel and above the headlight, and having a fluid passageway and washer fluid discharge apertures which allow placement of the washer fluid over the surface of the headlight. In addition, there are a multitude of long, short and offset fluid passageways leading to the several apertures of varying size and slanted inwardly, which discharge washer fluid over the surface of the headlight. In the system shown in Roth the apertures discharge washer fluid in a downward and inward fashion over the limited area of the headlight, and do not operate in conjunction with or as a part of a windshield washer/wiper system. In addition, although Roth might appear to provide a concealed system, at shown therein in FIG. 4, the assembly 21 ultimately protrudes in front of the lens 19 and is not therefore substantially hidden from view.

Accordingly, it is an object of this invention to overcome the disadvantages of the prior art and to provide for a less complex windshield washer system, wherein unsightly nozzles protruding through the hood or cowl have been eliminated.

It is also an object of this invention to provide an improved windshield washer system, wherein the tubing and couplings connecting the fluid reservoir to the spray delivery nozzles have been eliminated.

It is still a further object of this invention to provide an improved windshield washer reservoir and system wherein the pump or pressure delivery device is arranged in combination with the fluid reservoir.

### SUMMARY OF THE INVENTION

A vehicular surface washer spray system having at least one washer fluid reservoir and a sprayer, including a device for pumping the washer fluid from the reservoir to said sprayer, said sprayer being longitudinally disposed substantially along the periphery of the surface of a vehicle to be sprayed, and substantially hidden from external view, including a plurality of spaced openings longitudinally disposed and selectively positioned in said sprayer and angled toward said surface such that the washer fluid is selectively discharged through said openings in said sprayer onto a selected region of said vehicle surface.

In alternative embodiment, the present invention also comprises an integrated vehicular surface washer spray system comprising a washer fluid reservoir and a sprayer, including a device for pumping the washer fluid from the reservoir to said sprayer, said sprayer being longitudinally disposed substantially along the periphery of the surface of a vehicle to be sprayed, and substantially hidden from external view, including a plurality of spaced openings longitudinally disposed and selectively positioned in said sprayer and angled toward said surface such that the washer fluid is selectively discharged through said openings in said sprayer onto a selected region of said vehicle surface.

### BRIEF DESCRIPTION OF THE DRAWINGS

In the drawings, like reference numerals and characters designate like elements and parts throughout the figures, in which:

FIG. 1 is a perspective view of an automobile disclosing an embodiment of the present invention, a sprayer apparatus located at the base of the windshield containing a plurality of spaced holes;

FIG. 2 is a side view of a sprayer apparatus located at the base of the windshield and windshield wiper;

FIG. 3A is a perspective view of the sprayer apparatus with spaced longitudinal slits;

FIG. 3B is a perspective view of the sprayer apparatus with spaced cross slits;

FIG. 4 is a perspective and cutaway view disclosing another embodiment of the present invention, an automobile windshield washer reservoir and spray system;

FIG. 5A is a top view of a windshield washer system for an automobile with two windshield wipers located at the base of the windshield, with a plurality of spaced holes;

FIG. 5B is a top view of a windshield washer system for an automobile with one windshield wiper located at the base of the windshield, with a plurality of spaced slits;

FIG. 6 is a top view of an automobile showing the windshield washer system and windshield wipers oscillating in the direction of the arrows;

FIG. 7 is a side view of a windshield washer system located at the base of the windshield and windshield wiper;

FIG. 8 is a view similar to FIG. 1 and showing an alternative embodiment of a windshield washer system for an automobile made in accordance with the present invention; and

FIG. 9 is a view similar to FIG. 3A, and showing yet another alternative embodiment to the present invention.

### DETAILED DESCRIPTION OF THE PREFERRED EMBODIMENTS

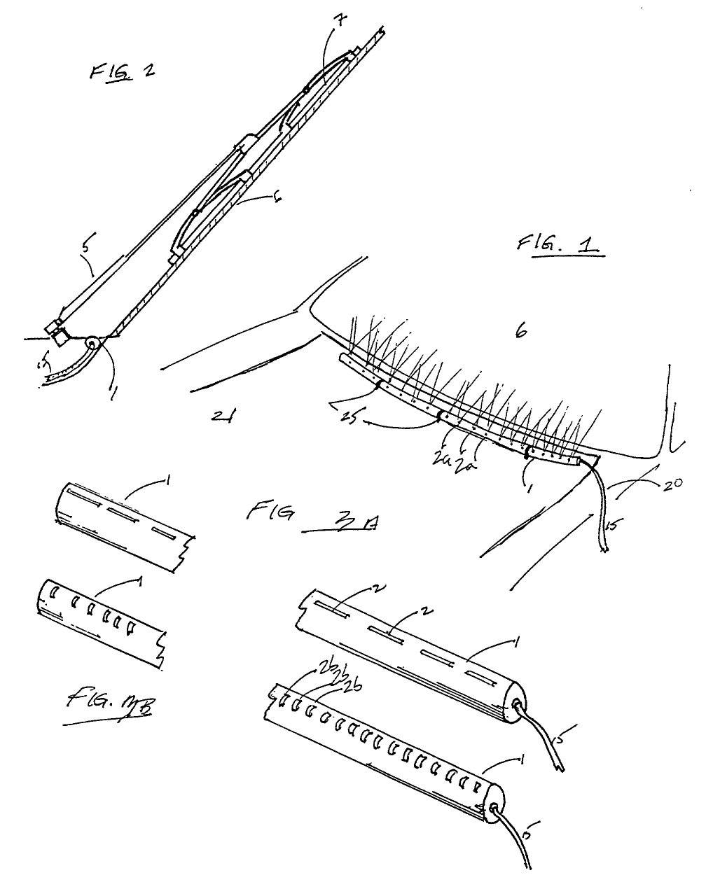

Referring to FIG. 1, there is shown a perspective view of a vehicle describing a first embodiment of the present invention comprising a sprayer apparatus 1 located at the area at the base of the windshield 6 in accordance with the present invention. The sprayer apparatus 1, as shown, can also be described as a bladder-type device, and as shown fitted about the periphery of the automotive windshield. As illustrated, the sprayer is substantially hidden from external view, and a plurality of openings 2a, whose geometry and location are selected to provide an optimum cleaning pattern on the windshield 6.

It is to be noted that although, as shown in FIG. 1, the invention herein is preferably placed into operation to wash and clean a windshield, the present invention, including the alternative preferred embodiments discussed herein, can be applied to other surfaces of the vehicle wherein cleaning is required. These include, without limitation, a vehicle windshield, window, headlamp, tail-light or external mirror and other similar type surfaces wherein safety considerations require the automated cleaning system of the present invention. In addition, although, as illustrated herein, the sprayer system is preferably shown to spray upwardly and onto the vehicle surface, it can be appreciated that the invention herein, as in the case, e.g., of a window or tail-light, may preferably be configured so that the sprayer delivers a cleaning spray from the top of the rear window or tail-light, as the case may be.

With attention again directed to FIG. 1, the sprayer 1 is shown connected to a fluid washer retainer or reservoir by flexible tube or hose 15 connected to a standard pumping device known in the art. In operation, the washer fluid is pumped under pressure from the reservoir though tube 15 to the sprayer 1. The washer fluid is discharged through openings 2a onto the surface of the windshield 6 and the windshield is cleaned by the conventional oscillating action of the wipers across windshield. As shown in FIG. 1, the sprayer 1, can preferably be held in place at the base of the windshield by a conventional bracketing device 25. Alternatively, the sprayer 1 may be located under the cowl of the automobile if the vehicle is so designed, or may be arranged on the underside of the hood 21 or contained within or as a part of the windshield trim.

As can also be appreciated from FIG. 1, the present invention eliminates the unsightly nozzle protruding through the hood or cowl of the automobile yet is of sufficient size to economically deliver under pressure a sufficient amount of washer fluid to the windshield 6. Further, the plurality of openings 2a in sprayer 1 allow for a more efficient washing and cleaning of the windshield by discharging fluid directly onto a greater area of the windshield surface than present systems. In addition, and as illustrated, the openings 2a are selectively spaced so that the washing and cleaning is targeted to those areas with greater intensity of washing and cleaning is desired, such as, e.g., the vision line (area directly in the path of the viewer's eyes) for the driver and frontseat passenger.

Sprayer 1 is also shown in relation to wiper 5 and windshield 6 in FIG. 2 As can be seen, in this alternative preferred embodiment, sprayer 1 is arranged between wiper 5 and the base of the windshield 6, although it can be appreciated that the sprayer 1 may be designed to be at various alternative locations in relation to the wiper mechanism so that it, as previously noted, remains substantially hidden from external view.

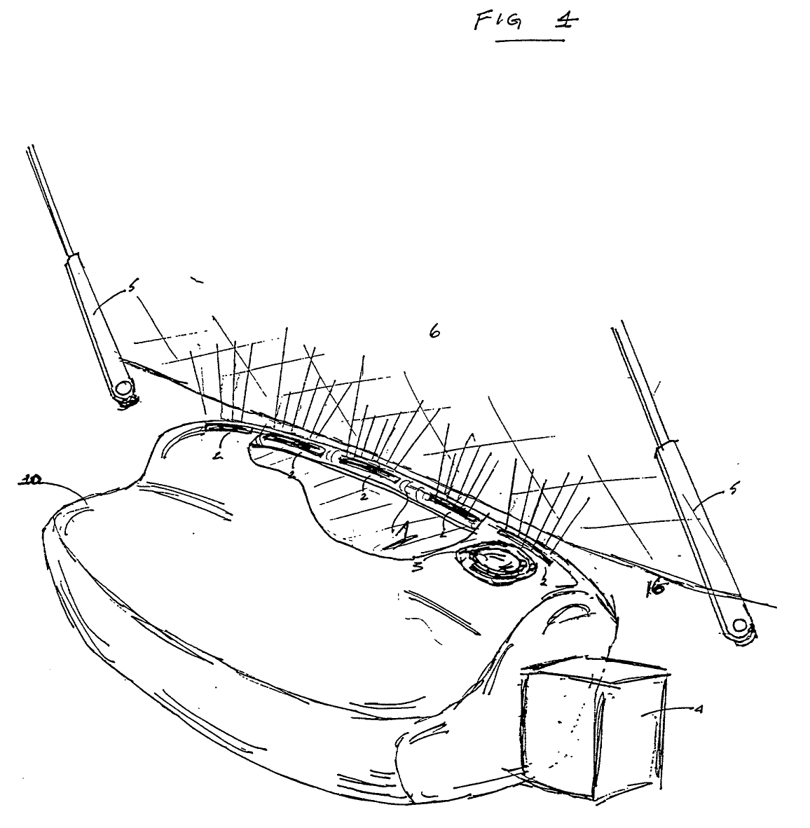

FIGS. 3A and 3B are perspective views of enlarged portion or sprayer 1 and flexible hose 15. FIG. 3A discloses a plurality of substantially longitudinal slits 2 in sprayer 1, spaced across the length of sprayer 1 so that the washer fluid may be discharged onto a substantial surface of the windshield, unlike nozzle spray devices which discharge the washer fluid onto more condensed areas of the windshield decreasing the effectiveness of the wiper as it moves across the surface of the windshield and often requiring that the washer system be activated several times in order to effectively clean the windshield. In addition, shown at 2b are square like openings in sprayer 1, which also will modify and accommodate the need to further adjust the spray pattern reaching the windshield surface. Accordingly, those skilled in the art will appreciate that by careful adjustment of the size and shape, or geometry and number of the opening, the spray pattern will be conveniently modified to reach and cover different extents of windshield surface.

Referring to FIG. 4, another preferred embodiment of the invention is disclosed showing an integrated windshield washer reservoir and spray system 10 with an electric pump 4. As illustrated therein, the washer fluid reservoir 10 is again preferably located at the base of the windshield 6 and positioned against the firewall 16 of the vehicle. In this embodiment, sprayer 1 is a part of reservoir 10 forming an integrated unit. With pump 4 preferably arranged alongside reservoir 10, the windshield washer system is in one location within and without the need for the customary flexible tubing that connects the various components of the system.

FIG. 4 also shows a two wiper configuration, with the reservoir and spray device 10 located between the wipers 5, and substantially midway the base of the windshield 6. In operation, the washer fluid retained in reservoir 10 is pumped under pressure by pump 4 into internal sprayer 1 through the slits 2 onto the surface of windshield 6. Washer fluid may be added to the system through removable filler cap 3.

In addition, various plastic material have been found suitable for the sprayer construction illustrated and shown herein. For example, plastic materials found suitable include materials such as polyethylene and polypropylene, specifically high-density polyethylene which can be conveniently molded into the various sprayer designs herein. Other suitable materials include engineering thermoplastic material resins such as acrylonitrile-butadiene-styrene resins, polyacetal, polycarbonate, thermoplastic polyesters, thermoplastic urethanes, thermoplastic olefins, EPDM, rubber and/or nylons. Of course, the selection of the particularly preferred plastic material is accomplished by selecting that material which is the most economical, is also most conveniently processed, and which provides under-the-hood durability with respect to the under-the-hood vehicular environment.

As can be appreciated, internal sprayer 1 will preferably be of thicker construction than reservoir 10 in order to accommodate the washer fluid pressure when the apparatus is in operation. In this embodiment, the slits 2 of sprayer 1 are angled so as to be discharging washer fluid over a substantial surface of the windshield 6 for greater and more efficient cleaning. In this embodiment, as with other embodiments of the invention, pumping may also sequenced so to match the sweep of the wiper or wipers 5 of the automobile.

As can be seen in FIG. 4, there are no protruding nozzles that must be taken into account for esthetic design purposes. In addition the sprayer system disclosed is less likely to clog or be blocked by snow or ice as is the case with customary nozzles.

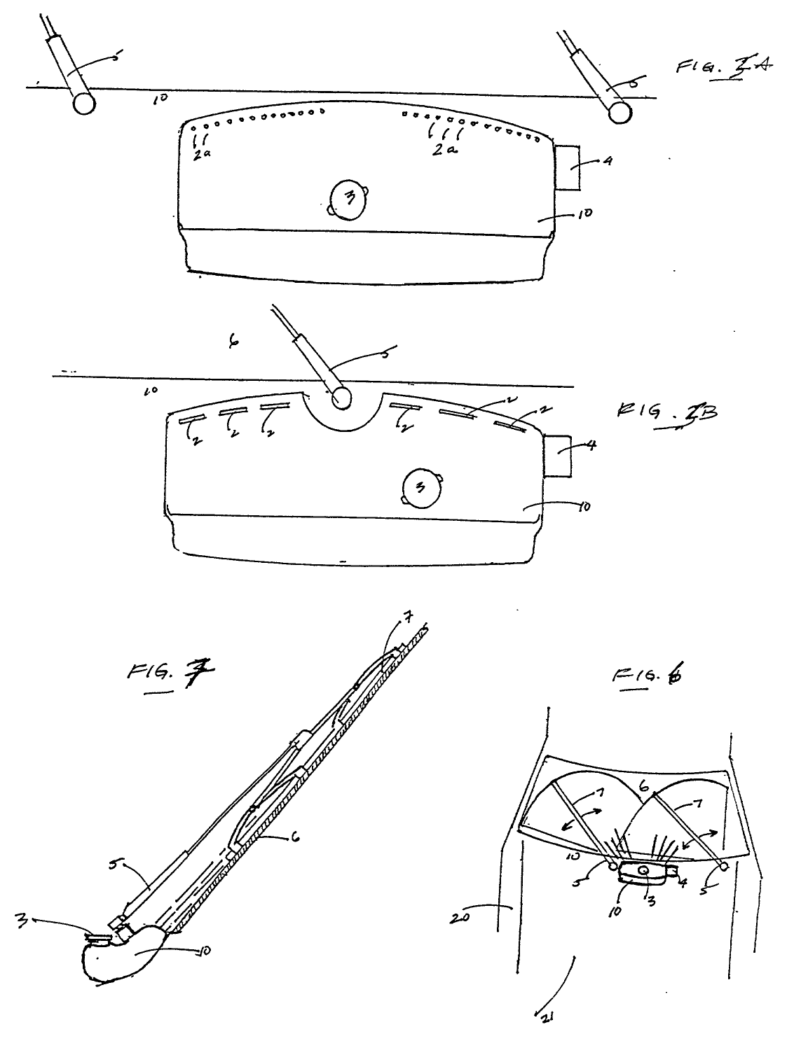

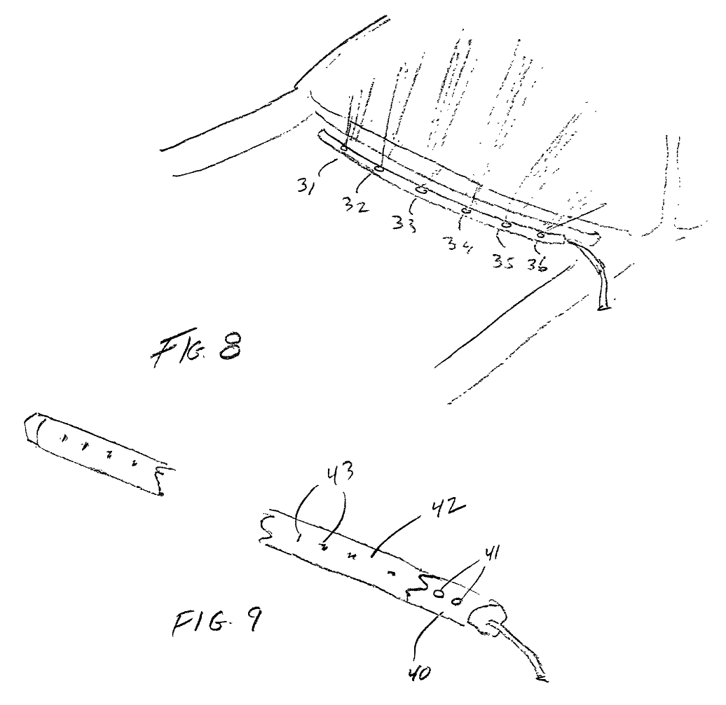

FIGS. 5A and 5B are both top views of two configurations of the integrated windshield washer reservoir and spray system 10. In FIG. 5A and FIG. 6 the washer fluid is discharged through holes 2a and shows two wipers 5. FIG. 5B shows one wiper 5 and the washer fluid is therein discharged through longitudinal slits 6. In addition, as shown in FIG. 5B the integrated washer reservoir and spray system contains what is best described as a cut-out section, or preferably, semi-circular cut-out section for position of the wiper blade 5. Accordingly, in both embodiments illustrated in FIGS. 5A and 5B, the system is designed to deliver washer fluid over a desired and substantial surface of the windshield 6 for maximum cleaning efficiency. In accordance with the present invention, this integrated embodiment is again preferably located at the base of the windshield 6 arranged under the hood 21 or cowl of the automobile 20, so as to be substantially hidden from external view. Finally, FIG. 7 shows reservoir 10 in relation to wiper 5 and windshield 6 in side view pursuant to the present invention.

The invention is susceptible to modification. For example, as shown at FIG. 8, the sprayer 1 may comprise a plurality of individual openings or spray jets 31 . . . 36 positioned and aimed so as collectively to cover essentially the entire arc wipe area. Thus, ideal distribution of water may be achieved. Also, by employing a plurality of fine jets or sprays, the driver's vision is not momentarily obscured as in the case of a conventional spray.

Other modifications are possible. For example, as seen in FIG. 9, the sprayer 1 may comprise a rigid or semi-rigid tubular tube or hose 40. The openings 41 may be formed in the tube 40, for example, by drilling or heat piercing. If desired, a resiliently deformable sleeve 42, for example, of silicone or the like, may be fitted over tube 40, with holes or slits 43 aligned with holes 41. Silicone sleeve 42 serves to seal the spray system and thereby provide leak-free operation.

Those skilled in the art will appreciate that still other modifications and variations of the present invention are possible in light of the above teachings. It is, therefore, to be understood that within the scope of the appended claims, the invention may be practiced otherwise than literally described, but fall within the scope therein. DECLARATION AND POWER OF ATTORNEY FOR PATENT APPLICATION Attorney Docket No: MWT A 4024 First Named Inventor: Thomas RUDEN and Stephen BURT Complete if known: Ser. No. Filing Date: Group Art Unit: Examiner: As a below named inventor, I hereby declare that: My residence, post office address and citizenship are as stated below next to my name. I believe I am the original, first and sole inventor (if only one name is listed below) or an original, first and joint inventor (if plural names are listed below) of the subject matter which is claimed and for which a patent is sought on the invention entitled CONCEALED VEHICULAR WASHER NOZZLE SYSTEM, the specification of which is attached hereto. I hereby state that I have reviewed and understand the contents of the above-identified specification, including the claims, as amended by any amendment referred to above. I acknowledge the duty to disclose information which is material to the examination of this application in accordance with Title 37, Code of Federal Regulations, S. 1.56(a). I hereby claim foreign priority benefits under 35 U.S.C. 119(a)-(d) or 365(b) of any foreign application(s) for patent or inventor's certificate, or 365(a) of any PCT international application which designated at least one country other than the United States of America, listed below and have also identified below any foreign application for patent or inventor's certificate or of any PCT international application having a filing date before that of the application on which priority is claimed: Prior Foreign Application(s): Certified Copy NONE Priority Claimed Attached Yes No Yes No (Number) (Country) (Month/Day/Year Filed) I hereby claim the benefit under 35 U.S.C. 119(e) of any United States provisional application(s) listed below: Application No: Filing Date: N/A I hereby claim the benefit under 35 U.S.C. 120 of any United States application(s), or 365(c) of any PCT international application designating the United States of America, listed below and, insofar as the subject matter of each of the claims of this application is not disclosed in the prior United States or PCT International application in the manner provided by the first paragraph of 35 U.S.C 112, I acknowledge the duty to disclose information which is material to patentability as defined in 37 CFR 1.56 which became available between the filing date of the prior application and the national or PCT international filing date of this application: N/A US Parent Application No. Parent Filing Date Parent Patent Number or PCT Parent Appln. No. (if applicable) And I hereby appoint HAYES, SOLOWAY, HENNESSEY, GROSSMAN & HAGE, P.C., a firm composed of Oliver W. Hayes, Reg. No. 15,867; Norman P. Soloway, Reg. No. 24,315; William O. Hennessey, Reg. No. 32,032; Susan H. Hage, Reg. No. 29,646; Steven J. Grossman, Reg. No. 35,001; and Edmund Paul Pfleger, Reg. No. 41,252, or any of them, of 175 Canal Street, Manchester, N.H. 03101 (Telephone: 603-668-1400) my attorneys with full power of substitution and revocation, to prosecute this application and to transact all business in the Patent Office connected therewith. Please direct all future correspondence in connection with this application to the attention of Norman P. Soloway HAYES, SOLOWAY, HENNESSEY, GROSSMAN & HAGE, P.C., 175 Canal Street, Manchester, N.H. 03101 (Telephone: 603-668-1400). I hereby declare that all statements made herein of my own knowledge are true and that all statements made on information and belief are believed to be true; and further that these statements were made with the knowledge that willful false statements and the like so made are punishable by fine or imprisonment, or both, under Section 1001 of Title 18 of the United States Code and that such willful false statements may jeopardize the validity of the application or any patent issued thereon. Full name of sole or first inventor: Thomas RUDEN First Inventor's signature Residence: 31951 Partridge Lane #21, Farmington Hills, MI 48334-1376 Citizenship: USA Post Office Address: Same as Residence Full name of second joint inventor: Stephen BURT Second Inventor's signature Date Mar. 18, 1999 Residence: Sandford House, Skarries View Tokers Green Lane, Kidmore End, Reading, RG4 9EB Citizenship: British Post Office Address: Same as Residence IMPORTANT NOTICE RE DUTY OF CANDOR AND GOOD FAITH

The Duty of Disclosure requirements of Section 1.56(a), of Title 37 of the Code of Federal Regulations are as follows:

A duty of candor and good faith toward the Patent and Trademark Office rests on the inventor, on each attorney or agent who prepares or prosecutes the application and on every other individual who is substantively involved in the preparation or prosecution of the application and who is associated with the inventor, with the assignee or with anyone to whom there is an obligation to assign the application. All such individuals have a duty to disclose to the Office information they are aware of which is material to the examination of the application. Such information is material where there is a substantial likelihood that a reasonable examiner would consider it important in deciding whether to allow the application to issue as a patent. The duty is commensurate with the degree of involvement in the preparation or prosecution of the application.

By virtue of this regulation each inventor executing the Declaration for the filing of a Patent Application acknowledges his duty to disclose information of which he is aware and which may be material to the examination of the application.

Inherent in this is the duty to disclose any knowledge or belief that the invention:

(a) was ever known or used in the United States of America before his invention thereof;

(b) was patented or described in any printed publication in any country before his invention thereof or more than one year prior to the actual filing date of the U.S. patent application;

(c) was in public use or on sale in the United States of America more than one year prior to the actual filing date of the U.S. patent application; or (d) has been patented or made the subject of inventor's certificate issued before the actual filing date of the U.S. patent application in any country foreign to the United States of America on an application filed by him or his legal representatives or assigns more than twelve months before the actual filing date in the United States. NOTE: The “Information” concerned includes, but is not limited to, all published applications and patents, including applicant's and assignee's own, U.S. or foreign applications and patents, as well as any other pertinent prior art known, or which becomes known, to the inventor or his representatives. Where English language equivalents of foreign language documents are known, they should be identified and, when possible, copies supplied. Failure to comply with this requirement may result in a patent issued on the application being held invalid even if the known prior art which is not supplied is material to only one claim of that patent.

What is claimed is:

1. A vehicular surface washer spray system having at least one washer fluid reservoir and a sprayer, including a device for pumping the washer fluid from the reservoir to said sprayer, said sprayer being longitudinally disposed substantially along the periphery of the surface of a vehicle to be sprayed, and substantially hidden from external view, including a plurality of spaced openings longitudinally disposed and selectively positioned in said sprayer and angled toward said surface such that the washer fluid is selectively discharged through said openings in said sprayer onto a selected region of said vehicle surface.

2. The system of claim 1, wherein said sprayer is substantially hidden from view by placement at the base of the vehicle hood.

3. The system of claim 1, wherein said surface contains a trim component, and said sprayer is substantially hidden from view by containing said sprayer within said surface trim.

4. The system of claim 1, wherein said vehicle contains a cowl, and said sprayer is longitudinally disposed under said cowl of said vehicle.

5. The system of claim 1, wherein said openings in said sprayer comprise slits, holes, squares, oval shapes, and mixtures thereof.

6. The system of claim 1, wherein said surface of said vehicle is a vehicle windshield, window, headlamp, tail-light or external mirror.

7. The system of claim 1, wherein said sprayer is sleeved within a resiliently deformable member.

8. An integrated vehicular surface washer spray system comprising a washer fluid reservoir and a sprayer, including a device for pumping the washer fluid from the reservoir to said sprayer, said sprayer being longitudinally disposed substantially along the periphery of the surface of a vehicle to be sprayed, and substantially hidden from external view, including a plurality of spaced openings longitudinally disposed and selectively positioned in said sprayer and angled toward said surface such that the washer fluid is selectively discharged through said openings in said sprayer onto a selected region of said vehicle surface.

9. The integrated vehicular surface washer spray system of claim 8, wherein said surface to be sprayed is a windshield, and wherein said integrated surface washer spray system is positioned at the base of said windshield.

10. The integrated vehicular surface washer spray system of claim 8, wherein said spray system contains a cut-out section for placement of a windshield washer wiper.

11. The integrated vehicular surface washer spray system of claim 10, wherein said sprayer is manufactured from a plastic material.

12. The integrated vehicular surface washer spray system of claim 11, wherein said sprayer comprises a shaped plastic molding.

13. The integrated vehicular surface washer spray system of claim 12, wherein said spaced openings are formed in said molding by piercing or drilling.

14. The integrated vehicular surface washer spray system of claim 8, and further comprising a resiliently deformable sleeve covering said sprayer, at least in part, each sleeve having a plurality of spaced openings aligned with said plurality of spaced openings in said sprayer.
